(19) United States
(12) Patent Application Publication
(10) Pub. No.: US 2005/0180751 A1
(43) Pub. Date: Aug. 18, 2005

(54) Wavelength division multiplex optical telecommunications network

(76) Inventors: Nigel Wood, Brampton (GB); Rosemary Cush, Northampton (GB); Nicola Shaw, Abington (GB)

Correspondence Address: KIRSCHSTEIN, OTTINGER, ISRAEL;& SCHIFFMILLER, P.C., 489 FIFTH AVENUE, NEW YORK, NY, 10017, US

(21) Appl. No.: 10/503,908

(22) PCT Filed: Feb. 10, 2003
(86) PCT No.: PCT/GB03/00572

(30) Foreign Application Priority Data
Feb. 8, 2002 (GB) 0203037.7

(51) Int. Cl. H04J 14/02

(52) U.S. Cl. 398/83

(57) ABSTRACT

A wavelength division multiplex (WDM) optical telecommunications network comprises a plurality of nodes interconnected by optical fiber waveguides. Communication traffic is communicated between nodes by optical radiation modulated with the communication traffic, the radiation being partitioned into aplurality (N) of wavelength channels each channel having a discrete non-overlapping waveband. Each node drops at least one of the wavelength channels to thereby define a connection to the node and adds at least one wavelength channel to the network to define a connection to another node of the network. The network is characterized is that at least one node has ascribed to it a fixed subset of the N wavelength channels and drops each of the wavelength channels of the fixed subset from the network. The node further comprises a wavelength selectable transmitter capable of adding one or more of at least any of the remaining wavelength channels other than the subset to the network to define a connection to another node of the network.

This invention relates to wavelength division multiplex (WDM) optical telecommunications network and more especially to a re-configurable WDM telecommunications network

As is known, WDM optical telecommunications network comprise a plurality of spatially disposed nodes which are interconnected by optical fiber waveguides. Communication traffic is communicated between the nodes by optical radiation modulated by the communication traffic which is conveyed by the optical firers.

Optical radiation in the context of the present invention is defined as electromagnetic radiation having a free-space wavelength of 500 nm to 3000 nm, although a free-space of 1530 nm to 1570 nm is a preferred part of this range. In wavelength division multiplexing, the optical radiation is partitioned into a plurality of discrete non-overlapping wavebands, termed wavelength channels or optical channels, and each wavelength channel is modulated by a respective communication channel.

The connectivity between nodes, in terms of the routing of communication traffic, is determined by the waveband (wavelength) of the wavelength channel. Typically a single wavelength channel is ascribed to uniquely define a given connection between two nodes though it is known to use more than one wavelength channel for the same connection to increase transmission capacity.

One network topography, a ring configuration, is one in which the nodes are connected by the optical firers in a point-to-point serial manner to form an unbroken (closed) loop or ring configuration. At each node one or more drop optical (wavelength selective) filters are connected in series within the optical fiber ring and each removes (drops) a single wavelength channel from the WDM radiation passing around the ring whilst allowing the remainder of the wavelength channels to pass substantially unattenuated. Additionally, at each node, wavelength channels can be added to enable communication with other nodes.

WDM network configurations can comprise a full mesh in which every node, in terms of wavelength channel connection, is connectable to every other node, hub networks in which one node, termed a hub, is connected to every other node or linear networks in which nodes are connected in linear manner.

In general optical ring networks can be divided into passive networks which do not include optical amplification within the ring or at the nodes and active networks which include optical amplifiers (typically Erbium doped fiber amplifiers EDFAS) to compensate for loss within the network. The former are typically limited to a few tens of kilometes around the ring and are often used as part of local area networks, and are termed “metro” (metropolitan) networks. In order to keep cost to a minimum metro networks are generally non re-configurable (i.e. fixed wavelength allocation) systems in which the intercormection of nodes, which is determined by the wavelength channel allocation, is fixed from installation of the system. The PMM series of networks sold by Marconi Communications Limited of Coventry, England is an example of a non re-configurable metro network and is of the order of 10-200 km in circumference. The larger end of the range is an active network including EDFA amplification. The smaller end of the range is a passive network. In such a network wavelength channels are dropped at respective nodes using drop filters (dielectric interference filters) which have a fixed wavelength passband corresponding to the waveband of the wavelength channel it is designed to drop. Since the drop filters have a fixed wavelength characteristic, the wavelength channel allocation, and hence interconnection of nodes, cannot be re-configured. The only way to re-configure such a system would be to physically change the drop filters at each node, requiring a site attendance which is both time consuming and expensive. This is a notable disadvantage since metro networks are typically installed in locations such as business parks and large office blocks where there is frequently a need to re-configure the network, for example to change the transmission capacity of interconnections or to add or remove users.

Re-configurable WDM optical telecommunications networks are also known in the art One example is the PMA32 network produced by Marconi Communications Limited of Coventry, England. This network is a thirty two wavelength channel network that is fully re-configurable in that each node can be remotely re-configured to selectively add and/or drop any one of the thirty two wavelength channels. Such Re-configurability is achieved through the use of wavelength tuneable drop filters and wavelength tuneable optical transmitters for adding channels.

Fully re-configurable WDM networks are ideally suited for large networks, for example regional networks or networks handling traffic for a large city, though they are costly since every node has to have hardware which is capable of handling (dropping and/or adding) each of the wavelength channels supported by the network.

Although a fully re-configurable network, such as those described above, could be used in the metro environment, the cost would be prohibitively expensive and would also give a degree of flexibility beyond that which is usually required.

The inventors have appreciated that a need exists therefore for a WDM network which is at least partially re-configurable and which is economically viable for use in the metro environment.

In its broadest form, the invention resides in at least some of the nodes being configured to drop a fixed subset of the total number of wavelength channels supported by the WDM network and additionally having the capability of being able to selectively add any of the remaining wavelength channels.

More specifically, according to a first aspect of the invention there is provided a wavelength division multiplex (WDM) optical telecommunications network comprising a plurality of nodes interconnected by optical fiber waveguides, in which communication traffic is communicated between nodes by optical radiation modulated with the communication traffic, said radiation being partitioned into a plurality (N) of wavelength channels each channel having a discrete non-overlapping waveband (λ₁ to λ_{N}), wherein each node includes means for dropping at least one of the wavelength channels to thereby define a connection to said node and includes means for adding at least one wavelength channel to the network to define a connection to another node of the network, the network being characterized by: at least one node having ascribed to it a fixed subset (Mᵢ) of the N wavelength channels and including means for dropping each of the wavelength channels of the fixed subset (Mᵢ) from the network; and wavelength selectable means capable of adding one or more of at least any of the remaining wavelength channels other than the subset to the network to define a connection to another node of the network.

The present invention provide the advantage of a low-cost partially re-configurable network which is particularly suited to metro type networks which can be ring type or linear. However, the invention is also applicable to other network types.

Advantageously every node has ascribed to it a respective fixed subset of the total wavelength channels and includes means for dropping each of these wavelength channels from the network; and every node further includes wavelength selectable means for adding one or more of at least any of the remaining wavelength channels other than the respective subset to the network.

The means for adding the one or more wavelength channels preferably includes at least one wavelength selectable transmitter. Advantageously the, or each, wavelength tuneable transmitter is wavelength tuneable to transmit on any of the N wavelengths supported by the network Such an arrangement enables the same transmitter to be used at any node of the network. Advantageously the, or each, wavelength selectable transmitter comprises a tuneable laser such as a multi-stage wavelength tuneable laser. Preferably, the, or each, transmitter further comprises a variable optical attenuator (VOA) for controlling the power of the wavelength channel. Such an arrangement can be further set to maximum attenuation during wavelength tuning. The use of wavelength tuneable transmitters, which can be adjusted remotely, enables re-configuration of the network without the need for on-site engineers. This greatly reduces network maintenance costs.

In one configuration the wavelength channels of the fixed subset are contiguous and comprise a band of consecutive wavelength channels. Such an arrangement is beneficial in that the means for dropping the subset of wavelength channels can then conveniently comprise a broadband drop filter.

In an alternative configuration WDM network according the wavelength channels of the subset comprise a plurality of discrete wavelength channels which are non-contiguous. Preferably the means for dropping the subset of wavelength channels then comprises one or more fixed wavelength selective filters. In one arrangement the one more filters are configured to drop every Q^{th} (Q>1) wavelength channel.

Advantageously the node further comprises means for separating the respective wavelength channels of the subset. Such means can comprises a de-multiplexer such as an array waveguide grating or alternatively an multi-way (m-way) splitter and m optical filters to select a respective one of the wavelength channels of the subset.

Preferably the number of wavelength channels that can be added at the node is equal to the number of wavelength channels dropped at the node.

The network of the present invention finds particular application to a network in which the nodes are interconnected in a ring configuration.

Embodiments of the invention will now be described, by way of example only, with reference to the accompanying drawings, in which:

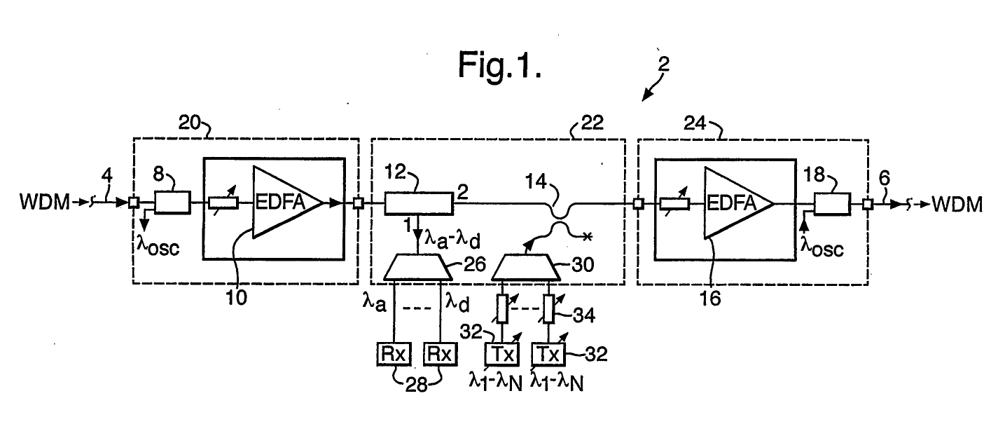

FIG. 1 shows a node in accordance with a first embodiment of the invention for use in a WDM optical telecommunications network;

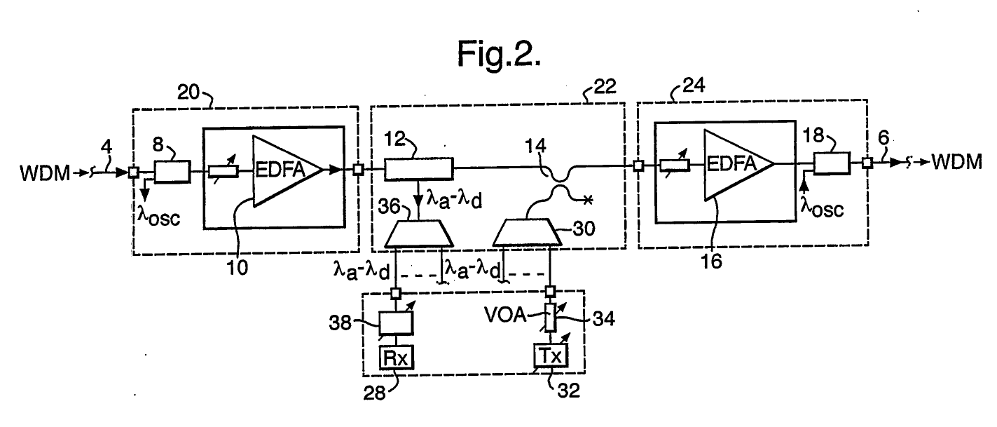

FIG. 2 shows a node in accordance with a second embodiment of the invention;

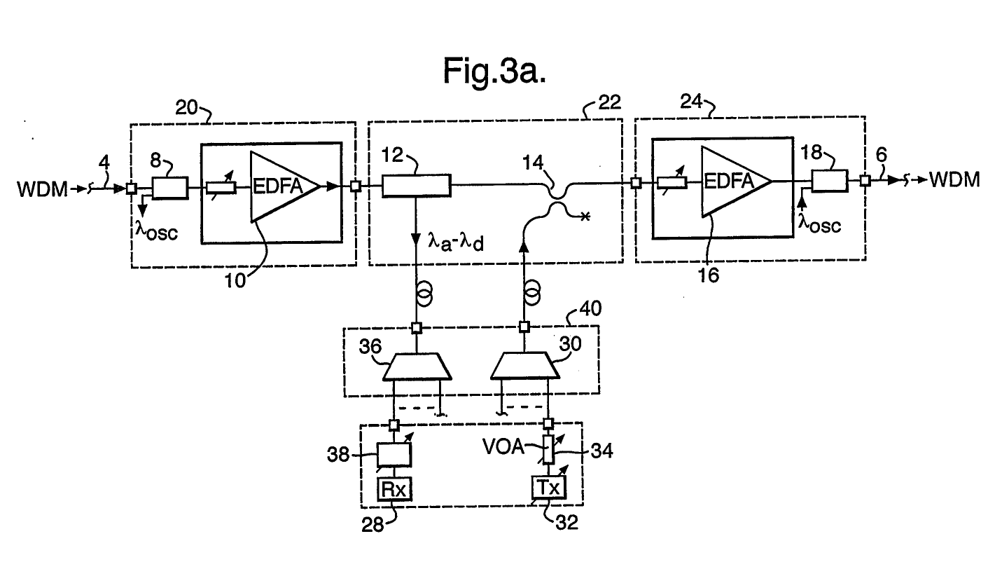

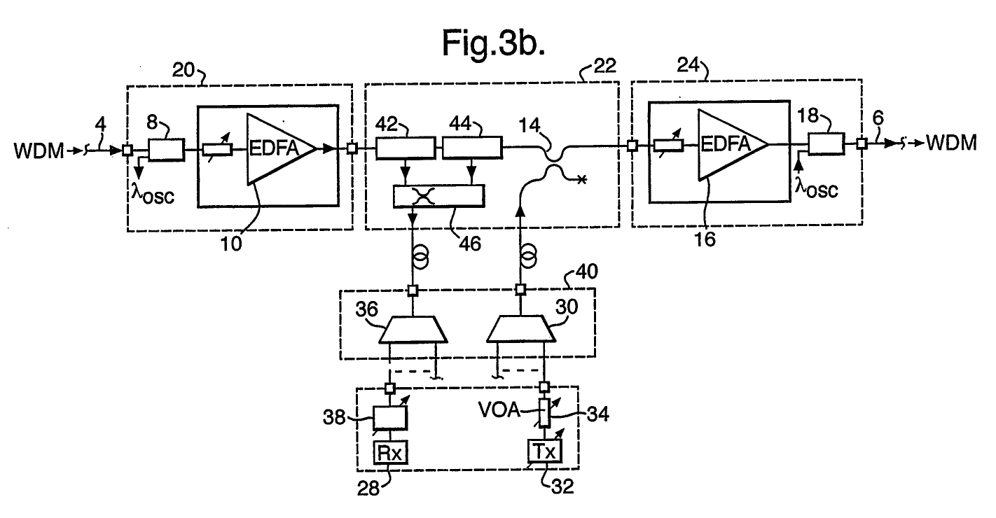

FIG. 3a shows a node in accordance with a third embodiment of the invention;

FIG. 3b shows an alternative implementation of the node of FIG. 3a;

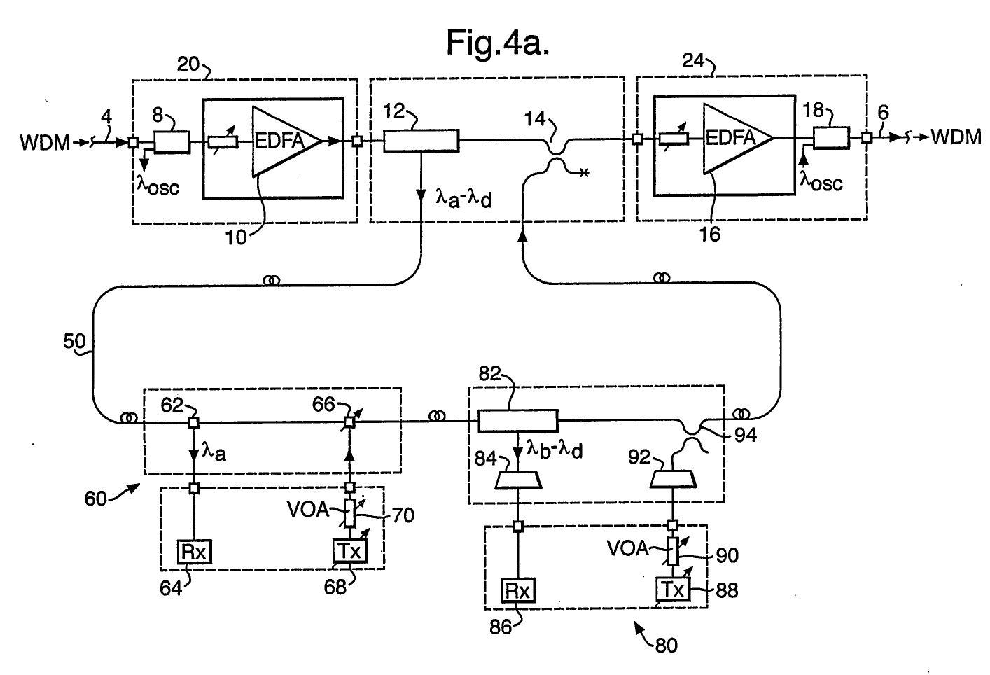

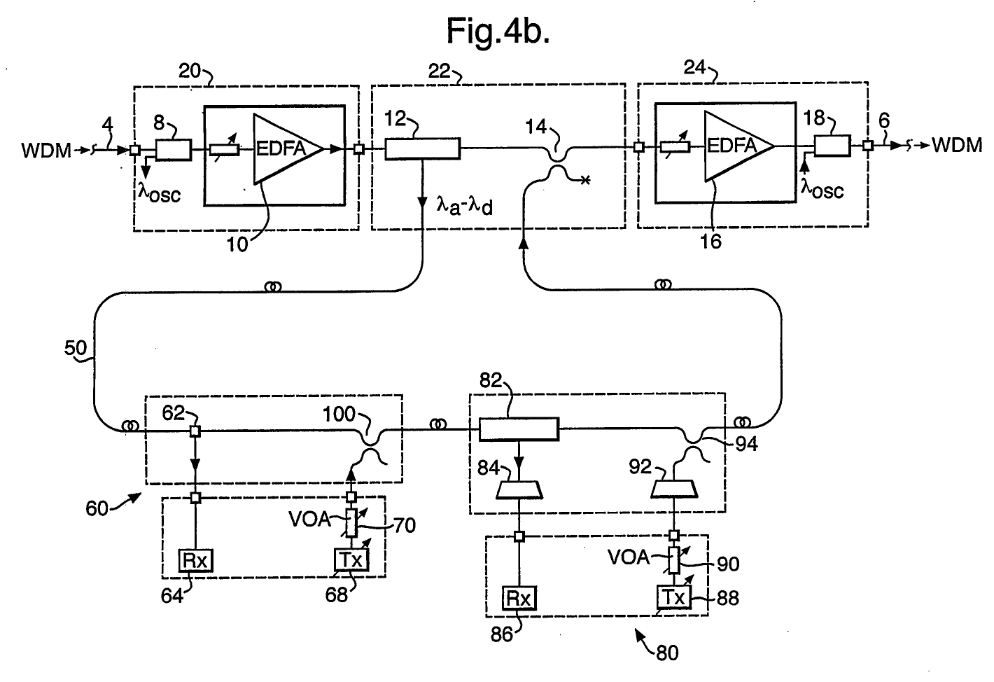

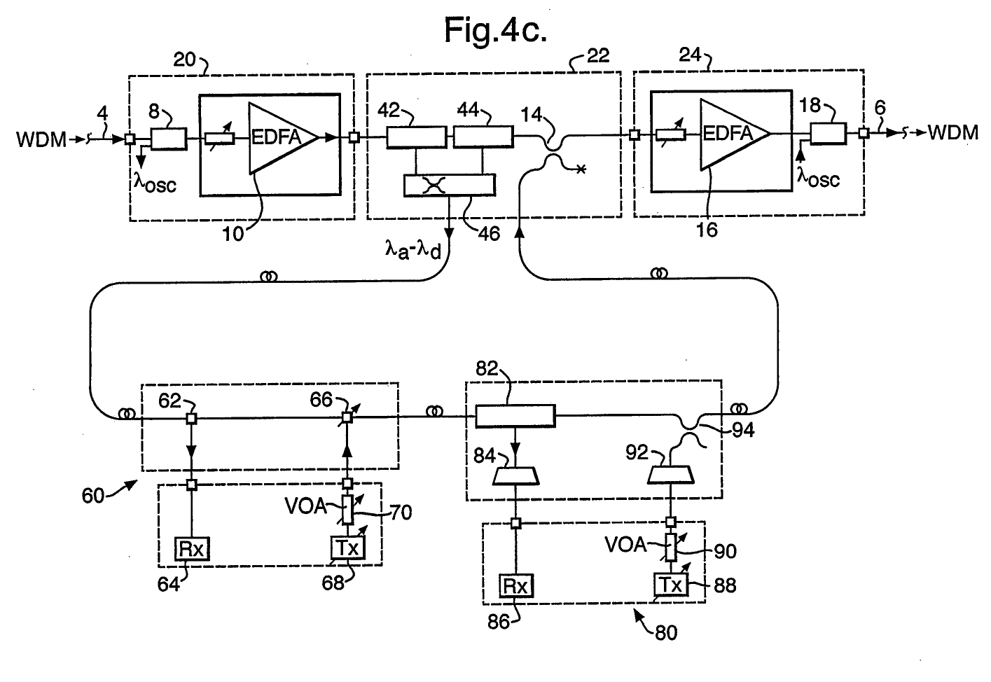

FIG. 4a shows a node in accordance with the invention with a sub-ring subtending from the node;

FIG. 4b shows an alternative realization of the embodiment of FIG. 4a;

FIG. 4c shows a further alternative realization of the embodiment of FIG. 4a; and

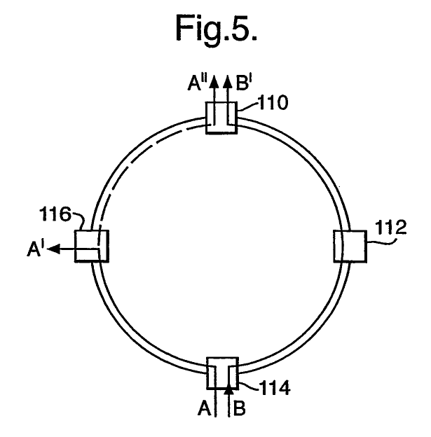

FIG. 5 shows a WDM ring telecommunications network embodying the invention.

Whilst each of the embodiments of the present invention to be described are primarily intended for use in metro WDM telecommunications network, passive or active, it should be understood that the invention is equally applicable to any type of WDM network such as regional ring networks or linear networks. In general metro networks have a ring configuration in which the nodes are serially connected by optical firers to form a closed loop or ring. The network can be protected or unprotected. In a protected network the nodes are connected by two separate optical fiber rings and WDM radiation is transmitted around the rings in clockwise and counter-clockwise directions respectively. As is known such an arrangement ensures a protection path is available in the event of a fiber break occurring. In the following description of the invention, and for the sake of brevity, an unprotected network is described in which there is only a single optical fiber connection between the nodes. The skilled person will, however, appreciate that the invention can be readily applied to a protected network.

All the embodiments to be described provide a partially re-configurable WDM network. The WDM network of the invention comprises n nodes and has N wavelength channels (λ₁ to λ_{N}). At least one, preferably all, of the models i (i=1 to n) has ascribed to it a fixed subset Mᵢ of the total N wavelengths channels carried by the network and includes means for dropping each of these fixed wavelength channels from the network. The subset ascribed to each node is unique to the node and comprises a plurality of wavelength channels. Additionally this/these models is/are capable of selectively adding any of the remaining N wavelength channels other than the subset of wavelength channels being dropped at the node (addition at a node of one of the wavelength channel which is one of the subset would define a connection to the same node). The subset Mᵢ of wavelength channels dropped at each of these nodes remains fixed and thus defines a fixed number m (equal to the number of wavelength channels in the subset Mᵢ) of connections to the node. The ability to be able to selectively add any of the remaining wavelength channels enables connections between nodes to be re-configured. A connection to a given node is established by selecting one of wavelength channels of the subset Mᵢ of the given node. Since number m of possible connections to each node is fixed, the system is partially re-configurable. Such a system is much cheaper than a fully re-configurable network since each node need only include hardware capable of dropping a fixed subset Mᵢ of the total number of wavelength channels.

In each of the embodiments, the subset Mᵢ of wavelength channels preferably comprises groupings of consecutive (adjacent) wavelength channels (i.e. bands of wavelength channels) thereby enabling the use of broadband filters to drop the subset of wavelength channels at each node. These filters may be dielectric filters or fiber Bragg grating filters for example. A series of filters could be used in place of a broadband filter though this is not favoured as the optical insertion losses (express path loss through the node) are too high. The wavelength channels of the subset can alternatively comprise different groupings of non-consecutive channels.

FIG. 1 shows a network node 2 embodying the invention. The node 2 is intended, for example, for use in a thirty two (N=32) wavelength channel (λ₁ to λ₃₂) WDM metro ring network operating at C-band (1530-1560 nm). In this embodiment, and in each of the following embodiments an optical supervisory channel (OSC) λ_{OSC}=1510 nm is used to support inter-node communications for network control and administration purposes. As is known the OSC does not carry communication traffic. Inter-node communications can alternatively be achieved by use of in-band management channels or by other means.

The node 2 comprises, serially connected between a network optical fiber 4 for receiving WDM radiation at the node and a network optical fiber 6 for outputting WDM radiation: a three port filter 8 for dropping the OSC, an optical amplifier (EDPA) 10, an optical drop filter 12, an optical coupler 14 for enabling wavelength channels to be added at the node 2, a second optical amplifier (EDFA) 16, and a second coupler 18 for adding the OSC to the WDM radiation output along the optical fiber 6. The OSC is dropped before the input of the EDFA 10 and added after the output of the EDFA 16 to maintain inter-node communication in the event of failure of either of the EDFAs. The optical amplifiers 10 and 16 compensate for inter-node radiation losses which are caused, for example, by optical fiber losses, filters, connectors and other components present in the optical path inter-connecting the nodes. Such optical amplification is of course optional and would be omitted in a passive network

For ease of manufacture the three port filter 8 and the first optical amplifier 10 are located on a receive (RX) line card 20; the optical drop filter 12 and coupler 14 are located on a card 22; and the optical amplifier 16 and the optical coupler are located on a transmit (TX) line card 24. The cards 20, 22, 24 are denoted by dashed lines in the Figure.

The optical drop filter 12 is preferably a three port filter and is configured to drop a fixed subset Mᵢ of the total number of wavelength channels N to a first optical output port whilst allowing the remainder of the wavelength channels to pass substantially unattenuated to a second optical output port which is connected to a first input of the coupler 14. The filter 12 is a broadband filter having a fixed wavelength characteristic which drops a number m, four in this example, consecutive (adjacent/neighboring) wavelength channels Mᵢ=λₐ to λ_{d}.

The card 22 additionally includes an optical de-multiplexer 26 (array waveguide grating AWG) whose input is connected to the first output of the optical drop filter 12 and which passively separates the subset Mᵢ of wavelength channels (λₐ to λ_{d}) into respective channels and routes each wavelength channel (λₐ to λ_{d}) along a respective optical path to a respective receiver 28. Moreover the card 22 includes a passive multi-input (p-way) optical combiner 30 (cascaded fused fiber coupler) for combining wavelength channels generated by a plurality p of optical transmitters 32. The output of the combiner 30 is connected to a second input of the optical coupler 14 which adds the radiation from the transmitters 32 to the WDM radiation passing through the node.

Typically the transmitters 32 comprise wavelength tuneable lasers which are capable of operating at any of the N wavelengths (λ₁ to λ_{N}) of the network. (Although it is unlikely that the transmitters will ever operated at any of the wavelengths of the respective subset Mᵢ it is preferred that each is capable of operation at all N wavelengths to enable the use of a single transmitter at any node). Each transmitter 32 preferably includes a variable optical attenuator (VOA) 34 for controlling the power of the wavelength channel being added to the network. Additionally each VOA 34 is preferably set to maximum attenuation during tuning, power-up and down of the laser to prevent output radiation being added to the network.

In operation the optical filter 12 drops the fixed subset Mi of the N wavelength channels and routes them to the de-multiplexer 26. The de-multiplexer 26 separates this subset into the m separate wavelength channels which are then received by their respective receiver 28. Additionally up to p wavelength channels can added to the network by means of the transmitters 32 to define connections to other nodes of the network. Since the wavelength of channels added by the node can be re-configured, by wavelength tuning the transmitters, this enables interconnection to other nodes to be at least partially re-configured.

The embodiment of FIG. 2 is similar to that of FIG. 1 and like components carry the same reference numerals. However, the optical de-multiplexer 26 is replaced by a passive multi-way (m-way) optical splitter 36 (cascaded fused fiber coupler) which divides radiation applied to its input equally between its m outputs. Each of the outputs of the splitter 36 contains each of the m wavelength channels dropped by the broadband drop filter 12 and each is applied to a respective wavelength selective filter 38. The wavelength selective filter is used to select a respective one of the m wavelength channels for reception by a respective receiver 28. Conveniently the filters 38 can be wavelength tuneable enabling a different receiver to be configured to receive a given wavelength channel. Such a capability is useful in the event of failure of a receiver.

The embodiment of FIG. 3a is identical to that of FIG. 2 except that the passive optical splitter 36 and the multiplexer 30 are arranged remote from the card 22 on a remote card 40. This arrangement is suitable where it is intended to locate the transmitters and receivers at a position remote from the node. Likewise it will be appreciated that the de-multiplexer 26 of FIG. 1 can be remotely located in a like manner.

In FIG. 3b, the broadband drop filter 12 is replaced with two or more wavelength selective filters 42, 44 and a passive optical combiner (cascaded fused fiber coupler) 46 which combines the outputs of two or more filters 42, 44. Such a filter arrangement is suited where the subset Mi of wavelength channels does not comprise a band of consecutive wavelength channels.

In the embodiment of FIG. 4a, the node drops the m (λₐ to λ_{d}) wavelength channels to a sub-ring 50 subtended from the node, which is part of a main network ring. The subtended ring 50 has a number of nodes, here two, each of which can drop out one or more of the m wavelengths supported by the sub-ring. Thus, in FIG. 4a, a first sub-node 60 of the subtended ring 50 has a drop filter 62 which drops out a single one (λₐ) of the m wavelength channels to a receiver 64. Additionally the node 60 includes a tuneable add filter 66 for adding a wavelength channel from a tuneable laser transmitter 68 back onto the subtended ring. A VOA 70 is placed between the transmitter 68 and the add filter 66 for reasons discussed previously. The tuneable laser transmitter 68 can transmit signals at any of the N wavelengths supported by the N channel network to enable communication with other nodes of the main network.

A second sub-node 80 on the subtended ring 60 includes a further broadband drop filter 82 which can drop out a subset (λ_{b} to λ_{d}) of the m channels supported by the subtended ring. The output of the filter is passed to a de-multiplexer 84 which has outputs corresponding to the individual wavelength channels dropped by the broadband filter 82 (only one is shown in FIG. 4a). Each of these wavelength channels can be received by a respective receiver 86.

As in the previous examples, the de-multiplexer 84 can be replaced by a passive optical splitter and tuneable or fixed wavelength filters. However, these are not preferred as they are more lossy than the de-multiplexer arrangement. This additional loss, together with the fiber loss of the subtended ring makes the approach less advantageous than using a de-multiplexer.

Additionally the sub-node 80 includes one or more tuneable laser transmitters 88, which have associated VOAs 90, and which provide one or more channels to a passive optical combiner 92 whose output is coupled back onto the subtended ring by a coupler 94. As before, the transmitter can be tuned to transmit at any of the N channels supported by the network as discussed in previous examples.

FIG. 4b shows a variant of the subtended ring of FIG. 4a in which the tuneable add filter 66, used for adding the wavelength tuneable channel onto the subtended ring, is replaced by a passive optical coupler 100.

FIG. 4c shows a further variant in which the broadband drop filter 12 is replaced by two or more separate filters 42, 44 and an optical combiner 46 in a manner similar to that of FIG. 3b.

FIG. 5 shows an example of a thirty two wavelength channel (λ₁ to λ₃₂) WDM ring network comprising four nodes (i=1 to 4) 110, 112, 114, 116. Each node is assigned a fixed subset Mᵢ of wavelength channels that it drops from the ring in this example each drops eight of the thirty two wavelength channels. The first node 110 is ascribed the wavelength channel subset M₁=λ₁ to λ₈, the second node 112 the subset M₂=λ₉ to λ₁₆, the third node 114 the subset M₃=λ₁₇ to λ₂₄, and the fourth node the subset M₄=λ₂₅ to λ₃₂. It follows from the foregoing description that each node includes means (drop filter) for dropping the eight wavelength channels ascribed to the node. It also follows that since each node is capable of adding wavelength channels corresponding to at least any of the remaining wavelength channels, each node can communicate with all the other nodes at any of their wavelengths.

The embodiments of the invention described provide a low cost partially re-configurable WDM network in which a fixed number of wavelength channels are dropped out at each node and in which each node can transmit at any of the other wavelengths supported by the network. Such a network is highly advantageous, particularly in the metro environment in which the network frequently requires re-configuring. Moreover, re-configuration can be done remotely. For example, the tuneable lasers can be adjusted from a remote management terminal on the network utilizing, for example, the optical supervisory channel. This greatly reduces the time delay and cost of re-configuring the network but without incurring hardware costs associated with the prior art fully re-configurable networks in which any of the wavelengths can be dropped at any of the nodes.

Various modifications are possible within the scope of the invention. For example, the subset of wavelength channels dropped at respective nodes can either be a band of consecutive wavelength channels, as in the examples described above, or be a grouping of non-consecutive wavelength channels. In the case of the latter, for example, every fourth wavelength channel can be selected using an interleaving type filter.

It will be appreciated that the transmitters can comprise a single tuneable transmitter or a plurality of fixed wavelength transmitters. In the embodiments described, the transmitters can transmit to all N wavelengths supported by the network. However, as described this is not essential. Alternatively each transmitter can cover a subset of the N wavelengths, for example, where the likely network configurations fall into an appropriate subset of the total.

Typically, the number m of wavelengths dropped at a node will in general equal the number p of wavelength channels added at the node. However, this may not always be the-case where bidirectional traffic is not always required, or where the bidirectional traffic is of a different nature in the two directions.

1-16. (canceled)

17. A wavelength division multiplex (WDM) optical telecommunications network, comprising:
a) a plurality of nodes interconnected by optical fiber waveguides in which communication traffic is communicated between the nodes by optical radiation modulated with the communication traffic, said radiation being partitioned into a plurality of wavelength channels each channel having a discrete non-overlapping waveband, each node including means for dropping at least one of the wavelength channels to thereby define a connection to said respective node, and each node including means for adding at least one of the wavelength channels to the network to define another connection to another node of the network;
b) at least one of the nodes having ascribed to it a fixed subset of the wavelength channels and including means for dropping each of the wavelength channels of the fixed subset from the network; and
c) wavelength selectable means for adding at least one of at least any of the remaining wavelength channels, other than the fixed subset, to the network to define still another connection to still another node of the network.

18. The WDM network according to claim 17, in which every node has ascribed to it a respective fixed subset of the wavelength channels and includes means for dropping each of the wavelength channels of the respective fixed subset from the network; and every node further includes wavelength selectable means for adding at least one of at least any of the remaining wavelength channels, other than the respective fixed subset, to the network.

19. The WDM network according to claim 17, in which the means for adding the at least one wavelength channel includes at least one wavelength selectable transmitter.

20. The WDM network according to claim 19, in which the at least one wavelength selectable transmitter is wavelength tuneable to transmit on any of the wavelength channels supported by the network.

21. The WDM network according to claim 19, in which the at least one wavelength selectable transmitter comprises a tuneable laser.

22. The WDM network according to claim 19, in which the at least one wavelength selectable transmitter further comprises a variable optical attenuator for controlling power of a respective wavelength channel.

23. The WDM network according to claim 17, in which the wavelength channels of the fixed subset are contiguous and comprise a band of consecutive wavelength channels.

24. The WDM network according to claim 23, in which the means for dropping the fixed subset of the wavelength channels comprises a broadband drop filter.

25. The WDM network according to claim 17, in which the fixed subset comprises a plurality of discrete wavelength channels.

26. The WDM network according to claim 25, in which the means for dropping the fixed subset of the wavelength channels comprises at least one fixed wavelength selective filter.

27. The WDM network according to claim 26, in which the at least one fixed wavelength selective filter drops every Q^{th} wavelength channel, where Q is greater than one.

28. The WDM network according to claim 17, and further comprising means for separating the respective wavelength channels of the fixed subset.

29. The WDM network according to claim 28, in which the means for separating comprises a demultiplexer.

30. The WDM network according to claim 28, in which the means for separating comprises an m-way splitter and m optical filters.

31. The WDM network according to claim 17, in which a number of the wavelength channels that can be added at the respective node is equal to a number m of the wavelength channels dropped at the respective node.

32. The WDM network according to claim 17, in which the nodes are interconnected in a ring configuration.
